(19) United States
(12) Patent Application Publication
(10) Pub. No.: US 2005/0248633 A1
(43) Pub. Date: Nov. 10, 2005

(54) High barrier ink conduit

(76) Inventors: Stephen F. DeFosse, Lexington, KY (US); James P. Drummond, Georgetown, KY (US); Steven R. Komplin, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/840,774

(22) Filed: May 6, 2004

(51) Int. Cl. B41J 2/175

(52) U.S. Cl. 347/85

(57) ABSTRACT

A method of fabricating a delivery conduit adapted to provide fluid communication between an off-carrier ink source and a printhead, the method comprising the steps of: (a) providing an ink conduit adapted to be in fluid communication with an off-carrier ink source and a printhead; and (b) laminating a fluid barrier layer over the ink conduit to substantially inhibit at least one of permeation of a fluid into the ink conduit from an external environment and permeation of a fluid from the ink conduit to the external environment.

### BACKGROUND

The present disclosure is related to inkjet printers; and more particularly, to ink conduits adapted to carry ink from an off-carrier ink reservoir to an on-carrier printhead, where the ink conduit may include a fluid permeation barrier layer.

Many inkjet printers and plotters use what is described as an off-carrier system, where the ink supply is located in an area remote from the actual inkjet printhead. Therefore, an ink transport system is required to provide a supply of ink to the printhead. In many of these transport systems, small diameter conduit is utilized to carry the ink between the remote location of the ink reservoir and the printhead. Likewise, such printing systems may be required to provide a continuous supply of ink to the printhead. One of the greater causes of interrupted supply of ink to the printhead stems from the loss of moisture from the ink through the small diameter conduit. Over extended periods of time, fluids (typically water) can permeate through the conduit and result in higher viscosity ink within the conduit, and even permanent aggregation of the ink components. Either of these circumstances may lead to poor performance of the printhead, and potentially to system failure. One other concern pertains to gas permeating into the conduit and aggregating therein and eventually making its way to the printhead. Such gases reaching the printhead may cause shorter printhead life or possible printhead nozzle starvation.

Fluid permeation through conduits may be measured in a variety of different ways. A first exemplary measurement technique may include filling the conduit with a fluid and measuring the change in weight over time to discern the amount of fluid diffusing therethrough. However, such a measurement may not fully take into account two-way permeation where liquid within the conduit is replaced by a gas. Another exemplary measurement technique may include passing a homogenous fluid through the conduit and monitoring for the presence of components other than the homogeneous fluid. As an example, oxygen permeation may be measured by introducing nitrogen gas at the inlet of a tube and allowed such gas to pass along the length of the tube prior to contacting an oxygen sensor at the outlet of the tube, thereby measuring the oxygen within the discharged nitrogen. An exemplary standard by which fluid permeation is measured is in grams of fluid diffusing per year.

Along with the need for ink conduit exhibiting high fluid barrier properties, there is also a need for flexibility and control along the length of the conduit as the printhead carrier is repeatedly shuttled across the print medium. The requirement of flexibility often runs counter to the requirement for high barrier properties, as most flexible conduit materials have relatively high moisture permeation and/or high gas permeation. Prior art techniques have included incorporation of high cost fluorinated materials or specially fabricated multi-layer conduit requiring unique and costly equipment to co-extrude the conduit and additional layers. Therefore, there is a need to provide a cost-effective method of rendering flexible conduit material sufficiently impervious to fluid permeation. Likewise, there is a need to provide a method of rendering commercially available flexible conduit sufficiently impervious to fluid permeation without requiring expensive, specialized co-extrusion equipment.

### SUMMARY

The present disclosure is related to inkjet printers; and more particularly, to ink conduit adapted for use with inkjet printers to provide fluid communication between one or more off-carrier ink reservoirs to one or more on-carrier printheads. The invention provides methods, and accompanying products resulting therefrom, for imparting barrier properties to virtually any conduit by forming a fluid barrier layer over the ink conduit. The present invention provides a more cost effective and simplistic system for imparting fluid permeation barriers than prior art techniques that relied on fluorinated materials and/or co-extrusion processes for forming an ink conduit and a barrier layer thereover. Likewise, the present invention is amendable to producing bundled ink conduits having more than one ink conduit in parallel, such as a ribbon structure where the conduit lays along the same plane, and a tubal structure where the entire conduit fails to lay along the same plane.

Accordingly, it is a first aspect of the invention to provide a method of fabricating a delivery conduit adapted to provide fluid communication between an off-carrier ink source and a printhead, the method comprising the steps of: (a) providing an ink conduit adapted to be in fluid communication with an off-carrier ink source and a printhead; and (b) forming a fluid barrier layer over the ink conduit to substantially inhibit fluid permeation into the ink conduit from an external environment.

In a detailed embodiment of the first aspect, the fluid barrier layer includes at least one of a metallic component, a silicon component, a polyester, a polyamide, and an olefin. In a more detailed embodiment, at least one of the metallic component, the silicon component, and the vinyl component is incorporated into a film comprising the fluid barrier layer. In yet a further detailed embodiment, the ink conduit includes at least one of (tube is not all that important and can comprise almost anything) polyethylene, nylon, fluorinated ethylene propylene, silicon, PVC, and perfluoroalkoxy. In another more detailed embodiment, the fluid barrier layer at least partially circumferentially surrounds the ink conduit. In yet another more detailed embodiment, the step of providing an ink conduit includes the step of providing a plurality of ink conduits. In a further detailed embodiment, the forming step includes forming the fluid barrier layer over the plurality of ink conduits to inhibit fluid permeation into the plurality of ink conduits from the external environment.

In an alternate detailed embodiment of the first aspect, the encapsulating layer and fluid barrier layer comprise a single film. In still a further more detailed embodiment, the forming step includes forming an encapsulating layer at least partially over the fluid barrier layer and at least partially over the plurality of ink conduits. In yet a further more detailed embodiment, the encapsulating layer and fluid barrier layer comprise a single film. In another detailed embodiment, the plurality of ink conduits are in parallel. In yet another more detailed embodiment, the plurality of ink conduits lay along the same plane in a ribbon structure. In still a further more detailed embodiment, the forming step includes forming an encapsulating layer at least partially over the fluid barrier layer.

It is a second aspect of the invention to provide a method of inhibiting fluid permeation through a permeable ink conduit, comprising the step of forming a fluid permeation inhibitor layer between a permeable ink conduit and an external environment to substantially inhibit permeation of fluids therebetween.

In a detailed embodiment of the second aspect, the method further comprises the step of interposing, at least partially, a protective layer in relation to the fluid permeation inhibitor layer and the external environment. In a more detailed embodiment, the interposing step includes the step of interposing, at least partially, the fluid permeation inhibitor layer in relation to an external environment and a plurality of permeable ink conduits to substantially inhibit permeation of fluids therebetween. In yet a further detailed embodiment, the plurality of permeable ink conduits are adapted to be aligned in parallel. In another more detailed embodiment, the plurality of permeable ink conduits are adapted to lay along the same plane in a ribbon structure. In yet another more detailed embodiment, the forming step includes application of at least one of thermal energy and pressure.

In an alternate detailed embodiment of the second aspect, the forming step includes the use of at least one of rollers and a mold. In a more detailed embodiment, the forming step includes the use of rollers, where the rollers are compliant and the barrier layer is formed about the permeable ink conduit. In yet a further detailed embodiment, the forming step includes the step of forming a fluid permeation inhibitor layer between a plurality of permeable ink conduits and the external environment to substantially inhibit permeation of fluids therebetween. In another more detailed embodiment, the forming step includes the use of a mold, where the mold includes a cavity adapted to receive a portion of the permeable ink conduit. In yet another more detailed embodiment, the forming step includes the step of forming the fluid permeation inhibitor layer between a plurality of permeable ink conduits and the external environment to inhibit permeation of fluids therebetween.

It is a third aspect of the invention to provide an ink delivery system adapted to provide fluid communication between an off-carrier ink reservoir and an on-carrier printhead, the ink delivery system comprising: (a) an ink conduit adapted to convey ink between an off-carrier ink reservoir and an on-carrier printhead; and (b) a fluid permeation layer laminated over the ink conduit that substantially inhibits fluid permeation between the ink conduit and an external environment.

In a detailed embodiment of the third aspect, the ink conduit comprises a polymer conduit at least partially encapsulated by the fluid permeation layer. In a more detailed embodiment, the system further comprises a plurality of ink conduits including the fluid permeation layer laminated thereover to substantially inhibit fluid permeation between the plurality of ink conduits and the external environment. In yet a further detailed embodiment, the plurality of ink conduits are adapted to provide fluid communication between a plurality of off-carrier ink reservoirs and a printhead. In another more detailed embodiment, the plurality of ink conduits are adapted to be aligned in parallel. In yet another more detailed embodiment, the plurality of ink conduits are adapted to lay along the same plane in a ribbon structure.

It is a fourth aspect of the present invention to provide an inkjet printer comprising: (a) an on-carrier inkjet printhead; (b) an ink delivery system adapted to provide fluid communication between an off-carrier ink reservoir and the on-carrier printhead, the ink delivery system comprising: (i) an ink conduit adapted to convey ink between the off-carrier ink reservoir and the on-carrier printhead, and (ii) a fluid permeation layer laminated over the ink conduit to substantially inhibit fluid permeation between the ink conduit and an external environment; and (c) an electronic controller adapted to be in electrical communication with a digital device for receiving printing instructions and converting those printing instructions to control the on-carrier inkjet printhead.

### BRIEF DESCRIPTION OF THE DRAWINGS

FIG. 1 is an exemplary schematic diagram of an ink flow pathway of an inkjet printer including a cut-away view a first exemplary embodiment of the present invention;

FIG. 2 is a diagram of a second exemplary embodiment of the present invention incorporated into an inkjet printer;

FIG. 3 is an end view of the second exemplary embodiment of the present invention;

FIG. 4 is an end view of a second alternate exemplary embodiment of the present invention;

FIG. 5 is an end view of an exemplary adapter in accordance with of the present invention;

FIG. 6 is a cross-sectional view of the exemplary adapter of FIG. 5;

FIG. 7 is an end view of a third alternate exemplary embodiment of the present invention;

FIG. 8 is a partial diagram of a first exemplary machine capable of producing the exemplary embodiments of the present invention; and

FIG. 9 is a partial diagram of a second exemplary machine capable of producing the exemplary embodiments of the present invention.

### DETAILED DESCRIPTION

The exemplary embodiments of the present invention are illustrated and described below as steps, options, and mechanisms for carrying out desired processes and products resulting therefrom. The various orientational, positional, and reference terms used to describe the elements of the invention are utilized according to such exemplary steps, options, and mechanisms. However, for clarity and precision, only a unitary orientational or positional reference will be utilized; and, therefore it will be understood that the positional and orientational references used to describe the elements of the exemplary embodiments of the present invention are only used to describe the elements in relation to one another.

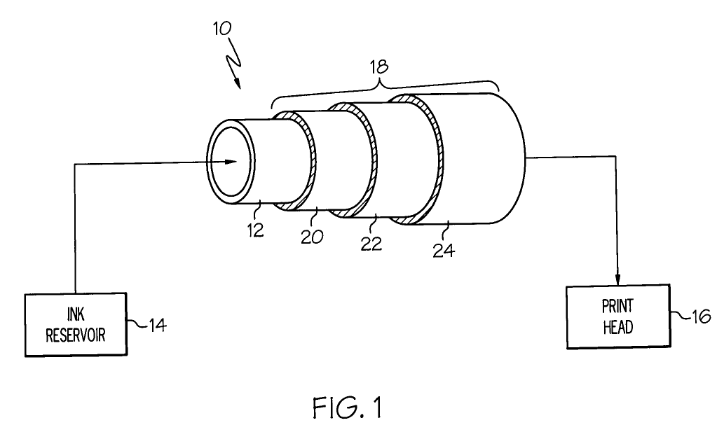

Referring now to the drawings, and in particular to FIG. 1, a first exemplary ink conduit 10 includes a core conduit 12 adapted to carry ink from an off-carrier ink reservoir 14 to an on-carrier printhead 16. The core conduit 12 includes a film 18 distributed thereabout. Exemplary materials for the core conduit 12 include, without limitation, polymers such as polyethylene (PE), nylon, fluorinated ethylene propylene (FEP), perfluoroalkoxy (PFA), as well as elastomers. The film 18 comprises a first polymer layer 20, a barrier layer 22, and a second polymer layer 24 that seal the core conduit 12 to substantially inhibit fluid permeation into and from the core conduit 12. Exemplary materials for the barrier layer 22 include, without limitation, metallic foils, silicon dioxide layers (SiO₂), polyvinylidene chloride layers (PVDC), ethylene vinyl alcohol layers (EVOH), nanoclay oxides, metallic oxide such as Al₂O₃, rolled metallic layers and vapor deposited metallic layers, olefins, liquid crystal polymers, nylons, and polyesters. While the film 18 discussed above incorporates three layers, it is within the scope of the invention that the film 18 incorporate less than three layers, so long as a barrier layer is present to substantially inhibit fluid permeation into or from the core conduit 12. Exemplary materials for the first and second polymer layers 20, 24 include, without limitation, polymers such as PE, a pressure sensitive adhesive (PSA), as well as elastomers. Those of ordinary skill will readily understand that certain combinations of barrier layers 22 and polymer layers 20, 24 will provide selective fluid permeation barriers for particular fluids and that selective combinations of layers 20, 22, 24 will provide selective permeation barriers, such as, without limitation, water barriers and oxygen barriers, and such combinations are within the scope of the present invention.

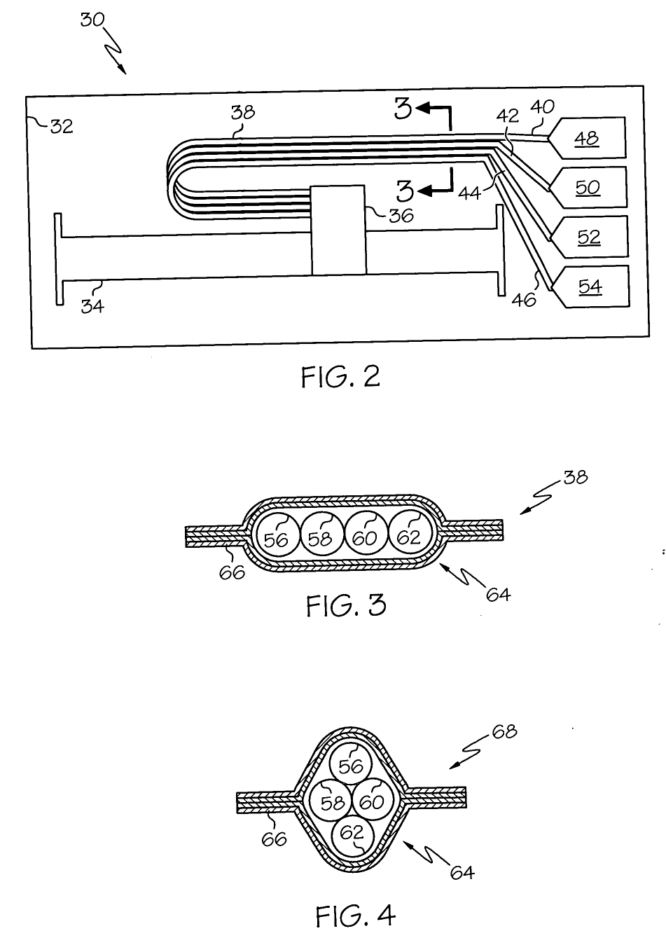

Referring to FIG. 2, an exemplary ink jet printer 30 incorporating the ink conduit of the present invention may also include a housing 32 mounted to a rail 34 that allows an on-carrier printhead 36 to horizontally traverse the width of a medium (not shown). The ink conduit of the present invention may include a ribbon structure 38 incorporating a plurality of ink conduits 40, 42, 44, 46 adapted to provide fluid communication between a respective plurality of off-carrier ink reservoirs 48, 50, 52, 54 and the on-carrier printhead 36. The rail 34 is adapted to guide the on-carrier printhead 36 across the width of the medium as the printhead 36 ejects droplets of ink to create one or more images thereon in response to signals from an electronic controller (not shown). The flexible nature of the ribbon structure 38 provides a continuous supply of ink to the printhead 36 and adapts to the position of the printhead to avoid impeding the progress thereof. The electronic controller is adapted to receive signals from a digital device (not shown), such as a computer, for generating printing instructions regarding the one or more images to be printed.

Referencing FIG. 3, the plurality of ink conduits 40, 42, 44, 46 of the ribbon structure 38 may be comprised of a plurality of primary ink conduits 56, 58, 60, 62 that are oriented in parallel and lay along the same plane. The ribbon structure 38 incorporates a film 64 having a fluid barrier layer 66 that is laminated over the conduits 56, 58, 60, 62 to seal the longitudinal length thereof against substantial fluid permeation into or from the conduits 56, 58, 60, 62.

Referring to FIG. 4, the conduits 56, 58, 60, 62 may likewise be oriented in parallel, but not along the same plane, to provide a tubular structure 68 resulting from the film 64 being laminated thereover. In such an exemplary instance, the conduits 56, 58, 60, 62 may be oriented in a diamond or other suitable geometric configuration to reduce the occupied volume of the resulting tubular structure 68. In either instance, the resulting structures 38, 68 provide a longitudinal barrier against substantial fluid permeation.

Exemplary forms of fluid permeation include, without limitation, water permeation and oxygen permeation. One of ordinary skill will recognize that permissible amounts of water permeation and oxygen permeation may be dependent upon the design of the printhead, the design of the ink reservoir, the function of the printhead, and/or the length of tubing spanning between the ink reservoir and the printhead.

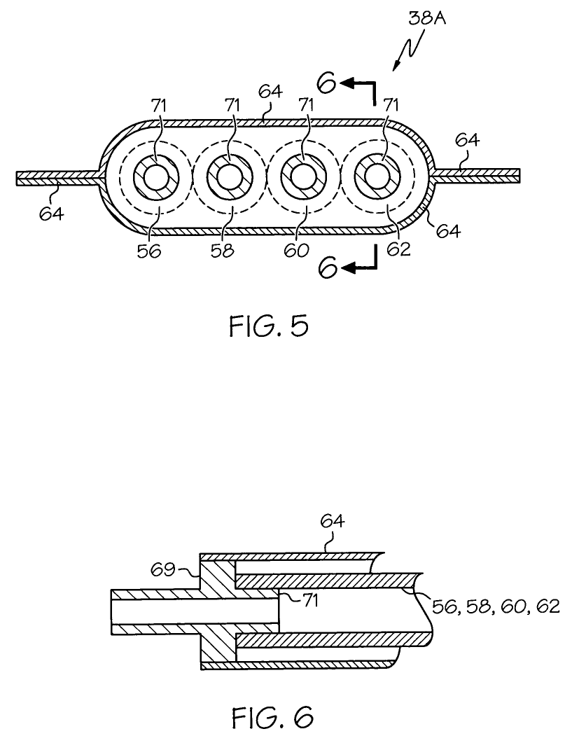

Referencing FIGS. 5 and 6, an exemplary embodiment of a ribbon structure 38A may include an adapter 69 mounted thereto. The adapter 69 may provide an intermediary with respect to the conduits 56, 58, 60, 62 and either the ink reservoir 48, 50, 52, 54 and the printhead 36. In accordance with the principles of the present invention, the film 64 and adapter 69 may provide a fluid barrier between the interior of conduits 56, 58, 60, 62 and an external environment. The adapter 69 may include a male projection 71 adapted to provide a friction fit with a conduit 56, 58, 60, 62 to mount the conduit to the adapter 69. Likewise, it is within the scope of the invention that the adapter 69 include a female receiver (not shown) to receive a portion of each conduit 56, 58, 60, 62 therein to provide a friction fit therebetween. Still further, it is within the scope of the invention that one or more conduits 56, 58, 60, 62 may be positioned adjacent to, or spaced from, the adapter 69 and secured by a friction fit from the film 64 being mounted to the adapter 69.

Referring to FIG. 6, an exemplary fluid tight seal may result from the film 64 being mounted to the adapter 69, but not necessarily mounted to the conduits 56, 58, 60, 62. In an exemplary embodiment where the film 64 is not mounted directly to the conduits 56, 58, 60, 62, the film 64 may be mounted to a first adapter 69 at the ink reservoir end and a second adapter 69 at the opposing printhead end. In such an exemplary embodiment, so long as the ink conduits 56, 58, 60, 62 are contained within a sealed shell, operatively supplied by the film 64 and the adapters 69, the fluid barrier layer features of the present invention may be preserved, thereby limiting fluid permeation into, and from, the interior of the conduits 56, 58, 60, 62.

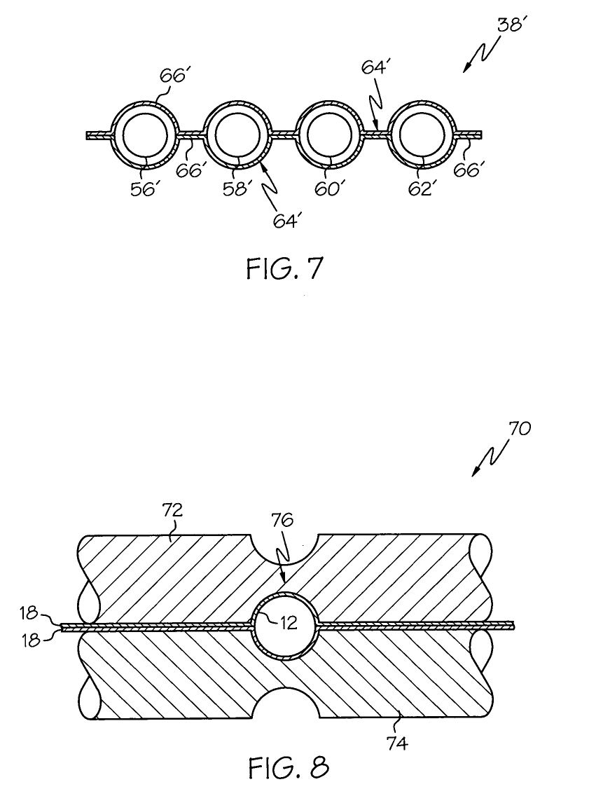

Referencing FIG. 7, an alternate exemplary embodiment of a ribbon structure 38′ may include a plurality of primary ink conduits 56′, 58′, 60′, 62′ that are in parallel and lay along the same plane. A film 64′ having a fluid barrier layer 66′ is laminated over the conduits 56′, 58′, 60′, 62′ to seal the longitudinal length thereof against substantial fluid permeation into or from the conduits. Each conduit 56′, 58′, 60′, 62′ is separated from the adjacent conduits as the film 64′ longitudinally encapsulates each conduit 56′, 58′, 60′, 62′ separately. As discussed above, the film 64′ includes a fluid permeation barrier layer 66′ and may comprise additional layers, such as, without limitation, layers of PE and other exemplary polymeric materials.

Exemplary materials for the primary conduits 56, 58, 60, 62, 56′, 58′, 60′, 62′ include, without limitation, PE, nylon, FEP, PFA, other polymers, and elastomers. Exemplary materials for the fluid barrier layer 66, 66′ include, without limitation, metallic foils, SiO₂ layers, PVDC layers, EVOH layers, nanoclay oxides, metallic oxide such as Al₂O₃, rolled metallic layers and vapor deposited metallic layers, olefins, liquid crystal polymers, nylons, and polyesters Exemplary materials that may also comprise the film 64, 64′, other than the barrier layer 66, 66′, include, without limitation, polymers such as PE, a pressure sensitive adhesive (PSA), and elastomers.

Referring to FIG. 8, an exemplary method of manufacturing the ink conduit 10 of FIG. 1 includes a machine 70 having a contoured top roller 72 and a contoured bottom roller 74 forming a gap 76 therebetween for accommodating throughput of the core conduit 12. The top roller 72 and the bottom roller 74 may include heating elements or other conduits therethrough to impart thermal energy to the core conduit 12 and film 18 passing therebetween. The core conduit 12 may be sandwiched between two or more separate pieces of the film 18, or may alternatively be wrapped in one or more layers of the film 18. The conduit 12 may be fed concurrently with the film 18 longitudinally between the contoured rollers 72, 74 and through the gap 76. Pressure and/or thermal energy from the contoured rollers 72, 74 effectively bond the film 18 to itself and/or to the conduit 12, whether the film is wrapped or matted, to longitudinally encapsulate the core conduit 12.

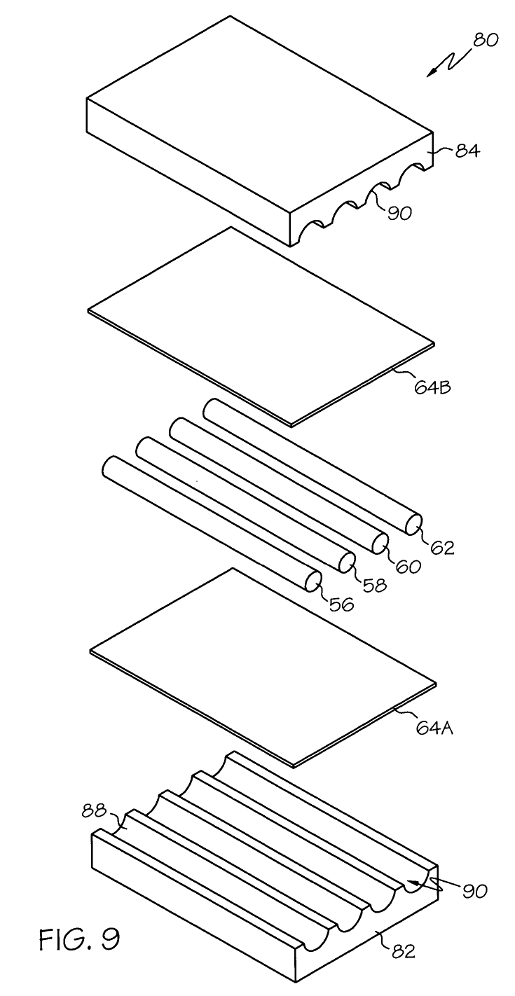

Referencing FIG. 9, an exemplary method of manufacturing the ribbon structure 38 of FIG. 3 includes a mold 80 that may include two corresponding mold sections 82, 84. The mold sections may include one or more cavities 86 therein adapted to receive the plurality of primary ink conduits 56, 58, 60, 62 and the film 64. As discussed above, the film 18 may be circumferentially wrapped around the plurality of primary ink conduits 56, 58, 60, 62 or may include more than one piece of film 64 overlying the plurality of primary ink conduits 56, 58, 60, 62.

The exemplary process may include two pieces of film 64A, 64B draped over opposite circumferential aspects of the plurality of primary ink conduits 56, 58, 60, 62. The first piece of film 64A is placed on top of the first mold section 82 and aligned to ensure coverage over the longitudinal length of the first mold section and along the longitudinal length of the primary ink conduits 56, 58, 60, 62. The plurality of primary ink conduits 56, 58, 60, 62 are positioned to be longitudinally aligned within a series of troughs 88 that correspond to the troughs 90 of the second mold section 84 to define the cavities 86. Likewise, a second piece of film 64B is longitudinally aligned with the second mold section 84 to ensure coverage over the longitudinal length of the primary ink conduits 56, 58, 60, 62. The first mold section 82 is aligned and positioned with the second mold section to sandwich the first and second pieces of film 64A, 64B and the plurality of primary ink conduits 56, 58, 60, 62. Pressure and/or thermal energy are applied to the first and second pieces of film 64A, 64B and the plurality of primary ink conduits 56, 58, 60, 62 to bond the first and second pieces of film 64A, 64B together and longitudinally encapsulate the plurality of primary ink conduits 56, 58, 60, 62 therebetween.

Those of ordinary skill will be familiar with the adaptation of the exemplary machines and techniques discussed above to manufacture the exemplary ink conduit embodiments of the present invention.

It is to be understood that the “ribbon structure” 38, 68, 38A discussed above provides dynamic control over the ink conduits 56, 58, 60, 62 in lieu of prior art techniques and apparatuses that maintained the dynamic control of multiple ink conduits between an ink source and a printhead such as, without limitation, clamps or rubber snaps.

It is also within the scope and spirit of the present invention to include fewer than four and greater than four ink conduits in a ribbon structure. It is likewise within the scope and spirit of the present invention to position the ink conduits adjacent to one another in a stacked manner that may include multiple ink conduits in parallel that lay along the same plane. Such a stacked structure would include a barrier layer to provide a fluid barrier between the interior of the ink conduits and the surrounding environment.

It is also within the scope and spirit of the present invention to utilize non-cylindrical conduits to provide fluid communication between an ink reservoir and a printhead. Such a non-cylindrical ink conduit may have an oval cross section, a hexagonal cross section, or other cross section known to those skilled in the art.

In accordance with the present invention, a number of experiments were conducted involving tubing capable of carrying ink therein. In a first exemplary experiment, a film 18, 64 comprising a polyethylene/ethylene vinyl alcohol/polyethylene sixty microns thick was mounted to Tygon® tubing in accordance with the present invention to create an experimental version. The experimental version included a Tygon® tube characterized as having an interior diameter of 1/16 of an inch and a wall thickness of 1/32 of an inch along the length of the tubing. A control version of the Tygon® tubing was the same length as the experimental version, but lacked the film 18, 64 along the length thereof. Tests were conducted to discern the amount of water loss in grams of water lost per year. The results of the testing reflected a four gram per year loss of water for the experimental version, while the control version reflected an eleven gram per year loss in water. Similar tests were conducted with silicon tubing in lieu of the Tygon® tubing with similar results. The experimental version of the silicon tubing included the PE/EVOH/PE film 18, 64 having a thickness of sixty microns mounted to a silicon tube in accordance with the present invention. The silicon tubing had an inner diameter of 1/16 of an inch and a wall thickness of 1/32 of an inch. The testing resulted in the control version of the silicon tubing rated at thirty grams of water loss per year, while the experimental silicon version was rated at eight grams of water loss per year.

Following from the above description and invention summaries, it should be apparent to those of ordinary skill in the art that, while the apparatuses herein described and illustrated constitute exemplary embodiments of the present inventions, it is understood that the inventions are not limited to these precise embodiments and that changes may be made therein without departing from the scope of the inventions as defined by the claims. Additionally, it is to be understood that the inventions are defined by the claims and it is not intended that any limitations or elements describing the exemplary embodiments set forth herein are to be incorporated into the meanings of the claims unless explicitly recited in the claims themselves. Likewise, it is to be understood that it is not necessary to meet any or all of the recited advantages or objects of the inventions disclosed herein in order to fall within the scope of any claim, since the inventions are defined by the claims and since inherent and/or unforeseen advantages of the present inventions may exist even though they may not have been explicitly discussed herein.

1. A method of fabricating a delivery conduit adapted to provide fluid communication between an off-carrier ink source and a printhead, the method comprising the steps of:
providing an ink conduit adapted to be in fluid communication with an off-carrier ink source and a printhead; and
laminating a fluid barrier layer over the ink conduit to substantially inhibit at least one of permeation of a fluid into the ink conduit from an external environment and permeation of a fluid from the ink conduit to the external environment.

2. The method of claim 1, wherein the fluid barrier layer includes at least one of a metallic component, a silicon component, a polyester, a polyamide, and an olefin.

3. The method of claim 2, wherein at least one of the metallic component, the silicon component, and the polyester, the polyamide, and the olefin is incorporated into a film comprising the fluid barrier layer.

4. The method of claim 1, wherein the ink conduit includes at least one of a polymer and an elastomer.

5. The method of claim 1, wherein the fluid barrier layer at least partially circumferentially surrounds the ink conduit.

6. The method of claim 1, wherein the step of providing an ink conduit includes the step of providing a plurality of ink conduits.

7. The method of claim 6, wherein the laminating step includes laminating the fluid barrier layer over the plurality of ink conduits to substantially inhibit at least one of permeation of the fluid into the plurality of ink conduits from an external environment and permeation of the fluid from the plurality of ink conduits to the external environment.

8. The method of claim 7, wherein the laminating step includes laminating an encapsulating layer at least partially over the fluid barrier layer and at least partially over the plurality of ink conduits.

9. The method of claim 8, wherein the encapsulating layer and fluid barrier layer comprise a single film.

10. The method of claim 7, wherein the plurality of ink conduits are in parallel.

11. The method of claim 10, wherein the plurality of ink conduits lay along the same plane in a ribbon structure.

12. The method of claim 1, wherein the laminating step includes laminating an encapsulating layer at least partially over the fluid barrier layer.

13. The method of claim 12, wherein the encapsulating layer and fluid barrier layer comprise a single film.

14. A delivery conduit fabricated in accordance with claim 1.

15. A delivery conduit fabricated in accordance with claim 5.

16. A plurality of delivery conduits fabricated in accordance with claim 9.

17. A plurality of delivery conduits fabricated in accordance with claim 11.

18. The method of claim 1, wherein the fluid barrier layer decreases water permeation into or from the ink conduit by more than fifteen percent.

19. The method of claim 1, wherein the fluid barrier layer decreases oxygen permeation into or from the ink conduit by more than fifteen percent.

20. A method of inhibiting fluid permeation through a permeable ink conduit, comprising the step of:
laminating a fluid permeation inhibitor layer between a permeable ink conduit and an external environment to substantially inhibit permeation of a fluid therebetween.

21. The method of claim 20, further comprising the step of interposing, at least partially, a protective layer in relation to the fluid permeation inhibitor layer and the external environment.

22. The method of claim 20, wherein the interposing step includes the step of interposing, at least partially, the fluid permeation inhibitor layer in relation to an external environment and a plurality of permeable ink conduits to substantially inhibit permeation of a fluid therebetween.

23. The method of claim 22, wherein the plurality of permeable ink conduits are adapted to be aligned in parallel.

24. The method of claim 23, wherein the plurality of permeable ink conduits are adapted to lay along the same plane in a ribbon structure.

25. The method of claim 20, wherein the laminating step includes application of at least one of thermal energy and pressure.

26. The method of claim 25, wherein the laminating step includes the use of at least one of rollers and a mold.

27. The method of claim 26, wherein the laminating step includes the use of rollers, where the rollers are compliant and the fluid permeation inhibitor layer is formed about the permeable ink conduit.

28. The method of claim 27, wherein the laminating step includes the step of forming a fluid permeation inhibitor layer between a plurality of permeable ink conduits and the external environment to substantially inhibit permeation of fluids therebetween.

29. The method of claim 26, wherein the laminating step includes the use of a mold, where the mold includes a cavity adapted to receive a portion of the permeable ink conduit.

30. The method of claim 29, wherein the laminating step includes the step of laminating the fluid permeation inhibitor layer between a plurality of permeable ink conduits and the external environment to substantially inhibit permeation of a fluid therebetween.

31. The method of claim 25, wherein the laminating step includes the step of mounting the fluid permeation layer to an adapter, where the adapter is adapted to be in fluid communication with the permeable ink conduit.

32. The method of claim 31, wherein the laminating step includes the step of mounting the fluid permeation layer to a plurality of adapters, where the plurality of adapters are adapted to be in fluid communication with at least one permeable ink conduit.

33. The method of claim 32, wherein at least two of the plurality of adapters are mounted to opposite ends of the fluid permeation layer, separating at least the one permeable ink conduit from the external environment.

34. An ink delivery conduit fabricated in accordance with claim 20.

35. An ink delivery conduit fabricated in accordance with claim 25.

36. A plurality of ink delivery conduits fabricated in accordance with claim 22.

37. A plurality of ink delivery conduits fabricated in accordance with claim 24.

38. The method of claim 20, wherein the fluid permeation inhibitor layer decreases water permeation into or from the permeable ink conduit by more than fifteen percent.

39. The method of claim 20, wherein the fluid barrier layer decreases oxygen permeation into or from the permeable ink conduit by more than fifteen percent.

40. An ink delivery system adapted to provide fluid communication between an off carrier ink reservoir and an on-carrier printhead, the ink delivery system comprising:
an ink conduit adapted to convey ink between an off-carrier ink reservoir and an on-carrier printhead; and
a fluid impediment layer laminated over the ink conduit that substantially inhibits permeation of a fluid between the ink conduit and an external environment.

41. The ink delivery system of claim 40, wherein the ink conduit comprises a polymer conduit at least partially encapsulated by the fluid impediment layer.

42. The ink delivery system of claim 41, further comprising a plurality of ink conduits including the fluid impediment layer laminated thereover to substantially inhibit permeation of a fluid between the plurality of ink conduits and the external environment.

43. The ink delivery system of claim 42, wherein the plurality of ink conduits are adapted to provide fluid communication between a plurality of off-carrier ink reservoirs and a printhead.

44. The ink delivery system of claim 42, wherein the plurality of ink conduits are adapted to be aligned in parallel.

45. The ink delivery system of claim 44, wherein the plurality of ink conduits are adapted to lay along the same plane in a ribbon structure.

46. An inkjet printer comprising:
an on-carrier inkjet printhead;
an ink delivery system adapted to provide fluid communication between an off-carrier ink reservoir and the on-carrier printhead, the ink delivery system comprising:
an ink conduit adapted to convey ink between the off-carrier ink reservoir and the on-carrier printhead, and
a fluid barrier layer formed over the ink conduit to substantially inhibit permeation of a fluid between the ink conduit and an external environment; and an electronic controller adapted to be in electrical communication with a digital device for receiving printing instructions and converting those printing instructions to control the on-carrier inkjet printhead.

47. A method of fabricating a delivery conduit adapted to provide fluid communication between an off-carrier ink source and a printhead, the method comprising the steps of:
providing an ink conduit adapted to be in fluid communication with an off-carrier ink source and a printhead; and
providing a fluid barrier layer over the ink conduit to substantially inhibit permeation of a fluid into the ink conduit from an external environment, the fluid barrier layer selected from the group consisting of a metal layer, a metal alloy layer, a silicon layer, a silicon oxide layer, a polyvinyl layer, an amalgam layer, and a composite layer.
